(19) United States
(12) Patent Application Publication
(10) Pub. No.: US 2016/0114469 A1
(43) Pub. Date: Apr. 28, 2016

(54) DISMANTLING DEVICE

(71) Applicant: Chiu-Chi LAI, Taichung (TW)

(72) Inventor: Chiu-Chi LAI, Taichung (TW)

(21) Appl. No.: 14/521,193

(22) Filed: Oct. 22, 2014

(51) Int. Cl. B25B 27/00; B25B 13/46

(52) U.S. Cl. CPC B25B 27/0042; B25B 13/463

(57) ABSTRACT

A dismantling device is provided, including a main body, a major sprocket, at least two rotating members and at least two clamping members. The main body has an axial direction, and the major sprocket is rotatably assembled with the main body. The at least two rotating members are pivotally disposed in the main body and arranged around the axial direction, and each rotating member includes a minor sprocket portion meshed with the major sprocket and a position-limiting portion. Each minor sprocket portion rotates about a central axis. The at least two clamping portions connect to the rotating members respectively and are rotatable around the corresponding central axes respectively. Each clamping member includes a restricting portion pivoted to the position-limiting portion and a clamping portion, wherein the restricting portion and the position-limiting portion are mutually restricted, and the restricting portion is restrictedly swingable within the position-limiting portion.

### BACKGROUND OF THE INVENTION

1. Field of the Invention

The present invention relates to a dismantling device, and more particularly to a dismantling device whose dimension is adjustable.

2. Description of the Prior Art

In the industry, motor oil serves as a lubricant to lubricate the elements of machines. After lubricating the elements, there are a lot of metal fragments of the elements in the motor oil. An oil filter cartridge is used to filter these metal fragments; however, when the metal fragments in the oil filter cartridge accumulate to a certain amount, the oil filter cartridge is blocked and loses the function of filtering. Therefore, the oil filter cartridge needs to be changed regularly. Dismantling devices disclosed in TWM448416 and TWI369282 can clamp oil filter cartridges in different dimensions.

However, a clamping portion of the conventional dismantling device can rotate 360 degrees. In actual practice, the clamping face needs to be adjusted to face the oil filter cartridge when a user wants to clamp the oil filter cartridge, and the working efficiency will be influenced.

The present invention is, therefore, arisen to obviate or at least mitigate the above-mentioned disadvantages.

### SUMMARY OF THE INVENTION

The main object of the present invention is to provide a dismantling device which can restrict a pivotally swinging angle of each clamping member. Therefore, a clamping face of each clamping portion normally faces an object to be clamped. When the object to be clamped is clamped, the clamping portion can swingably move in accordance with an outer surface of the object to be clamped so as to clamp the object tightly.

To achieve the above and other objects, the dismantling device of the present invention is provided, including a main body, a major sprocket, at least two rotating members and at least two clamping members. The main body has an axial direction. The major sprocket is rotatably assembled with the main body. The at least two rotating members are axially pivoted to the main body and arranged around the axial direction, and each rotating member includes a minor sprocket portion meshed with the major sprocket and a position-limiting portion. Each minor sprocket portion rotates about a central axis. The at least two clamping members are connected to the rotating members respectively and rotatable about corresponding central axes respectively. Each clamping member includes a restricting portion pivoted to the position-limiting portion and a clamping portion. The restricting portion and the position-limiting portion are mutually restricted, and the restricting portion is restrictedly swingable within the position-limiting portion.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferred embodiment of the present invention;

FIG. 2 is a breakdown drawing of FIG. 1;

FIG. 3 is a partial breakdown drawing of a preferred embodiment of the present invention;

FIG. 4 is a side cross-sectional view of a preferred embodiment of the present invention;

FIG. 5 is a partial stereogram of a preferred embodiment of the present invention in another mode;

FIG. 6 is a breakdown drawing of FIG. 5;

FIG. 7 is a partial sketch of a preferred embodiment of the present invention in still another mode;

FIGS. 8 and 9 are drawings showing a preferred embodiment of the present invention in use; and

FIGS. 10 and 11 are the other drawings showing a preferred embodiment of the present invention in use.

### DETAILED DESCRIPTION OF THE PREFERRED EMBODIMENTS

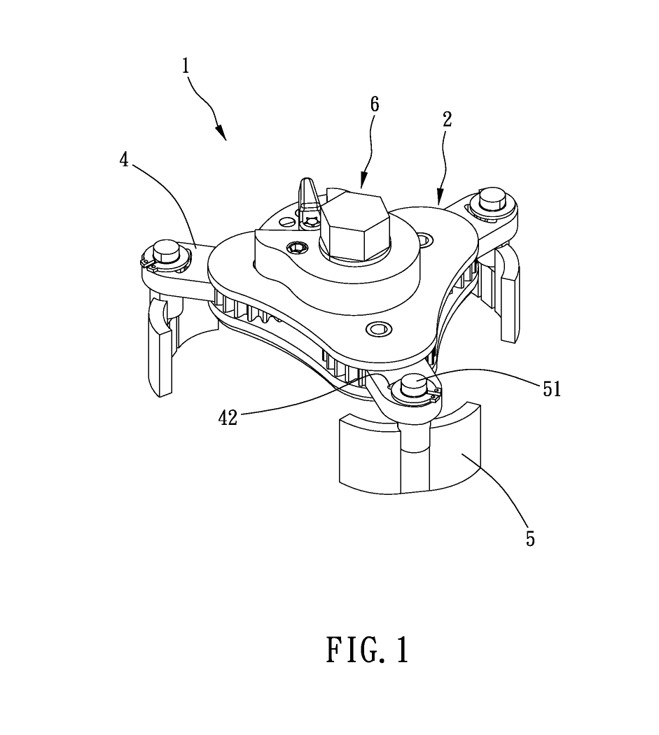

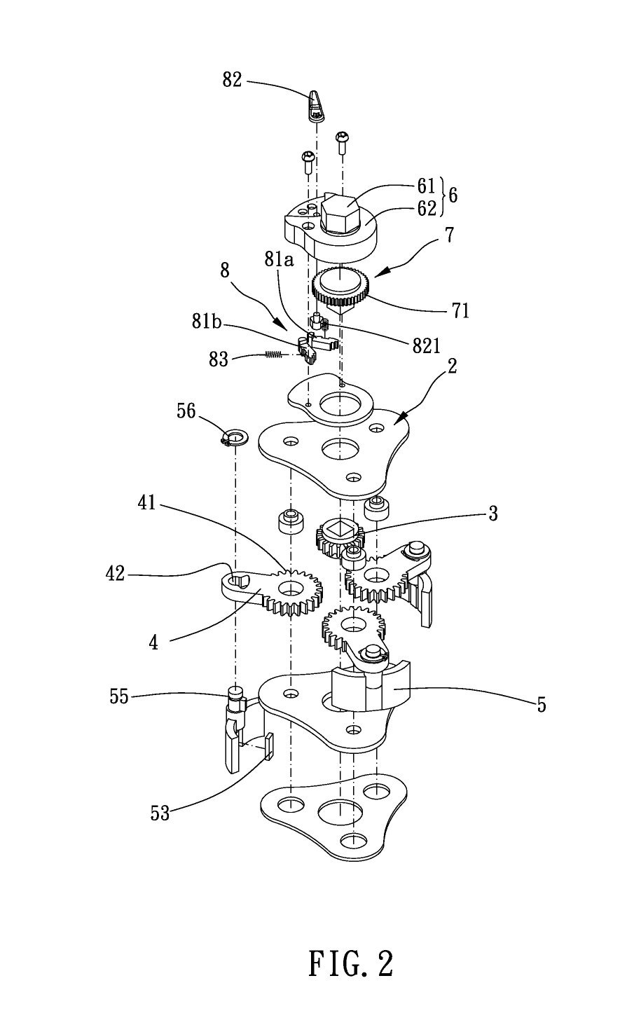

Please refer to FIGS. 1 to 4 for a preferred embodiment of a dismantling device of 1 the present invention, including a main body 2, a major sprocket 3, at least two rotating members 4 and at least two clamping members 5.

The main body 2 has an axial direction. The major sprocket 3 is rotatably assembled with the main body 2. The at least two rotating members 4 are axially pivoted to the main body 2 and arranged around the axial direction, and each rotating member 4 includes a minor sprocket portion 41 meshed with the major sprocket 3 and a position-limiting portion 42. Each minor sprocket portion 41 rotates about a central axis. In this embodiment, a number of the rotating members is three, and in other embodiments, the number of the rotating members 4 can be in other numbers. Preferably, in this embodiment, each rotating member 4 further includes an arm 43 extending radially outward from the minor sprocket portion 41, and each clamping member 5 is connected to one of the corresponding arms 43.

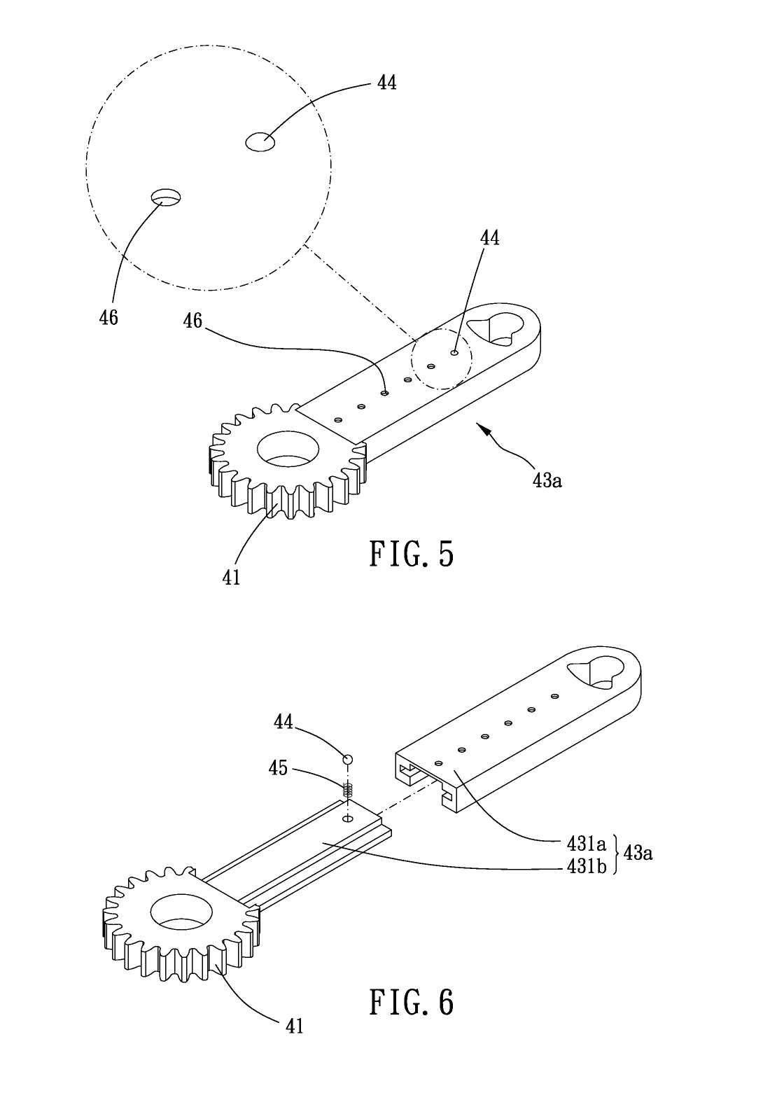

Please refer to FIGS. 5 and 6 for another embodiment of the present invention. Each arm 43a includes two rods 431a, 431b slidably assembled with each other. The two rods 431a, 431b can mutually slide to extend or shorten a length of the arm 43a so as to clamp an object to be clamped in different dimensions. The rod 431b has a rolling bead 44 and an elastic element 45, and the rod 431a has a plurality of through holes 46 so as to allow the rolling bead 44 to be selectively abutted against and stuck in one of the through holes 46 and to be restricted therewithin. In other embodiments, the arm 43a can be slidably disposed in other ways.

Please refer to FIGS. 1 to 4. The at least two clamping members 5 are connected to the rotating members 4 respectively and rotatable around the corresponding central axes respectively. Each clamping member 5 includes a restricting portion 51 pivoted to the position-limiting portion 42 and a clamping portion 52. A number of the clamping members 5 is equal to a number of the rotating members 4. The restricting portion 51 and the position-limiting portion 42 are mutually restricted, and the restricting portion 51 is restrictedly swingable within the position-limiting portion 42. Specifically, in this embodiment, in a corresponding pivotally swinging direction of the restricting portion 51, each position-limiting portion 42 has a blocking portion 421 on two sides of the restricting portion 51. Each restricting portion 51 includes a protruding portion 511 extending radially. The protruding portion 511 of each restricting portion 51 is restrictedly swingable between the two blocking portions 421, and the restricting portion 51 is restrictedly swingable between the two blocking portions 421. In addition, preferably, each position-limiting portion 42 further includes a slot 422 radially widening, and lateral walls of two sides of the slot 422 are formed with the blocking portion 421 respectively. The protruding portion 511 of each restricting portion 51 is restrictedly swingable between the two blocking portions 421 so as to restrict a rotating angle of each clamping member 5. In this embodiment, each restricting portion 51 is disposed at an interior of the position-limiting portion 42 and restricted between the two blocking portions 421 by the position-limiting portion 42. In other embodiments, each restricting portion 51 and the position-limiting portion 42 can restrict the rotating angle of the clamping member 5 in other ways, for example, each restricting portion 51 is disposed outside the position-limiting portion 42, and the two blocking portions 421 of the position-limiting portion 42 are disposed in the restricting portion 51 so as to restrict the rotating angle of the restricting portion 51. Preferably, each clamping member 5 is detachably connected to one of the corresponding rotating members 4. Specifically, in this embodiment, a top end of each clamping member 5 is formed with an annular recessed slot 55. When each clamping member 5 is disposed through each rotating member 4, each annular recessed slot 55 is detachably buckled by a C-shaped retaining ring 56; therefore, it is convenient to maintain and change each clamping member 5.

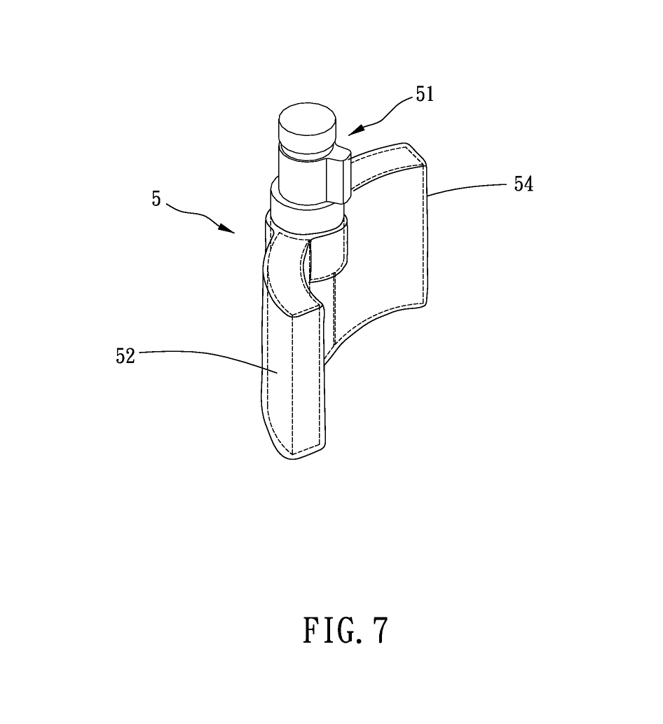

In this embodiment, preferably, each clamping portion 52 further includes a clamping recessed face 521, and each clamping recessed face 521 faces the central axis. A shape of each clamping recessed face 521 corresponds to a shape of the object to be clamped. Preferably, each clamping portion 52 has a magnetic member 53. Specifically, in this embodiment, each clamping member 5 has a recessed slot 531 corresponding to the magnetic member, and each magnetic member 53 is tight fit to the recessed slot 531 and disposed in the recessed slot 531. Each magnetic member has magnetism to attract the object to be clamped which is magnetic; therefore, when each clamping member 5 clamps the magnetic object to be clamped, the object to be clamped can be stably clamped. In other embodiments, each magnetic member 53 can be disposed in other ways. Furthermore, in other embodiments, preferably, each clamping member 5 further includes an outer layer 54 disposed on an outer surface of the clamping portion 52 (as shown in FIG. 7), and each outer layer 54 is an elastic plastic member covering the outer surface of the clamping portion 52. Each outer layer 54 can prevent an outer surface of the object to be clamped from being damaged when the clamping member 5 clamps the object.

This embodiment further includes a main rotating body 6, a ratcheting portion 7 and a restricting mechanism 8. The main rotating body 6 is rotatably assembled to the main body 2 and includes a driving portion 61 which can be operated from outside. In this embodiment, the driving portion 61 is a polygonal protruding body, and in other embodiments, the driving portion 61 can be the polygonal protruding body and/or a polygonal recessed portion recessed on the protruding body. The driving portion 61 can be operated with a tool corresponding to the driving portion 61 from outside the main body 2. The ratcheting portion 7 includes a ratchet 71 rotatably assembled to the main rotating body 6, and the major sprocket 3 links up with the ratchet 71. The restricting mechanism 8 includes at least one ratcheting member movably assembled to the main rotating body 6, and each ratcheting member includes at least one tooth selectively meshed with the ratchet 71. Preferably, the main rotating body 6 further includes a shell 62 protrudingly formed with the driving portion 61. The ratchet 71 is disposed in an interior of the shell 62, and the major sprocket 3 is disposed on an exterior of the shell 62. A portion of the main body 2 is arranged between the major sprocket 3 and the shell 62, and the at least one ratcheting member is assembled to the shell 62 and located inside the shell 62. Furthermore, in this embodiment, preferably, the restricting mechanism 8 includes two the ratcheting members and a switching member 82. The two ratcheting members include a first ratcheting member 81a and a second ratcheting member 81b. The switching member 82 is rotatably assembled to the main rotating body 6 and has an abutting block 821 disposed between the first ratcheting member 81a and the second ratcheting member 81b. In this embodiment, the switching member 82 is disposed on the exterior of the shell 62, and in other embodiments, the switching member 82 can be disposed in the interior of the shell 62. The switching member 82 is pivotally swingable between a first position and a second position. Preferably, the restricting mechanism includes at least one elastic member 83 elastically abutting against between the main rotating body 6 and the two ratcheting members. In this embodiment, a number of the at least one elastic member 83 corresponds to a number of the two ratcheting members, so the two ratcheting members tend to move toward and abut against the ratchet 71.

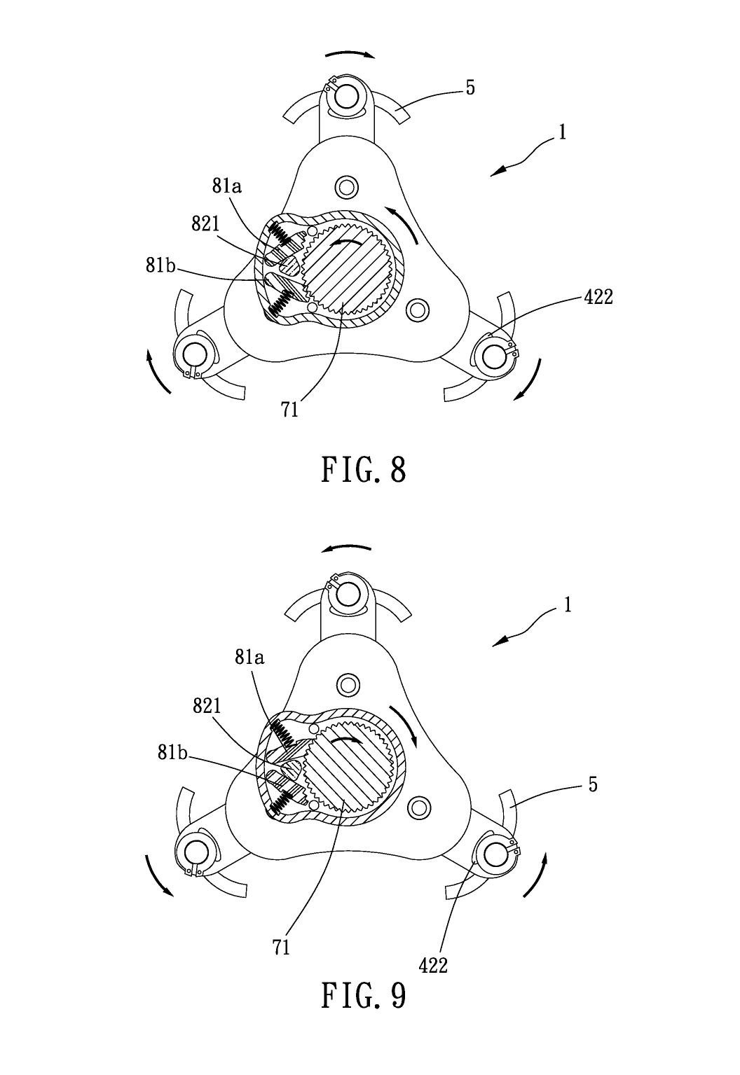

Please refer to FIGS. 8 and 9. In actual practice, when the switching member 82 is in the first position, the abutting block 821 abuts against and pushes the first ratcheting member 81a to make the first ratcheting member 81a unmeshed with the ratchet 71, and the second ratcheting member 811b is meshed with the ratchet 71. A tool is adapted to the driving portion 61 to provide a rotating force in a first rotating direction to rotate the driving portion 61, and the ratchet 71 is unrotatable. The main rotating body 6 can only be rotated in a first rotating direction (as illustrated by the arrows) relative to the ratcheting portion 7. When a rotating force in a second direction which is counter to a first rotating direction is applied to rotate the driving portion 61, the ratchet 71 is meshed with the second ratcheting member 811b to drive the major sprocket 3 to rotate. When the switching member 82 is in the second position, the abutting block 821 abuts against and pushes the second ratcheting member 81b to make the second ratcheting member 811b unmeshed with the ratchet 71, and the first ratcheting member 81a is meshed with the ratchet 71. The rotating force in the second rotating direction is applied to rotate the driving portion 61, and the ratchet 71 is unrotatable. The main rotating body 6 can only be rotated in the second rotating direction relative to the ratcheting portion 7. When the rotating force in the first rotating direction is applied to rotate the driving portion 61, the ratchet 71 is meshed with the first ratcheting member 81a to drive the major sprocket 3 to rotate.

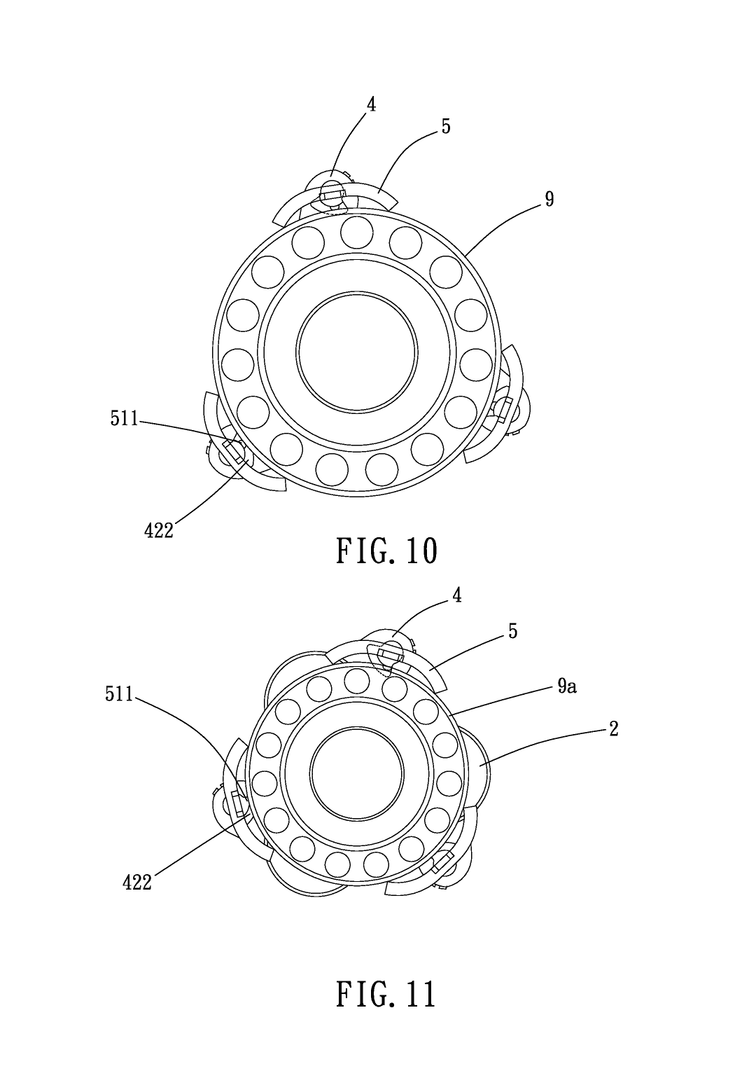

Please refer to FIGS. 10 and 11 for another embodiment that the present invention is applied to clamp two oil filter cartridges 9, 9a. When the ratcheting portion 7 drives each rotating member 4 to rotate, each rotating member 4 drives and continuously rotates the driving portion 61 to make each clamping member 5 close to the central axis. Thereby, each clamping member 5 tightly clamps the two oil filter cartridges 9, 9a in different dimensions and removes the two oil filter cartridges 9, 9a. In this embodiment, the present invention is used to clamp the two oil filter cartridges 9, 9a, and in other embodiments, the objects to be clamped can be other objects (for example, cans). Aside from stably clamping the object to be clamped and disassembling the object, the present invention can also clamp the object to be clamped to conduct assembling.

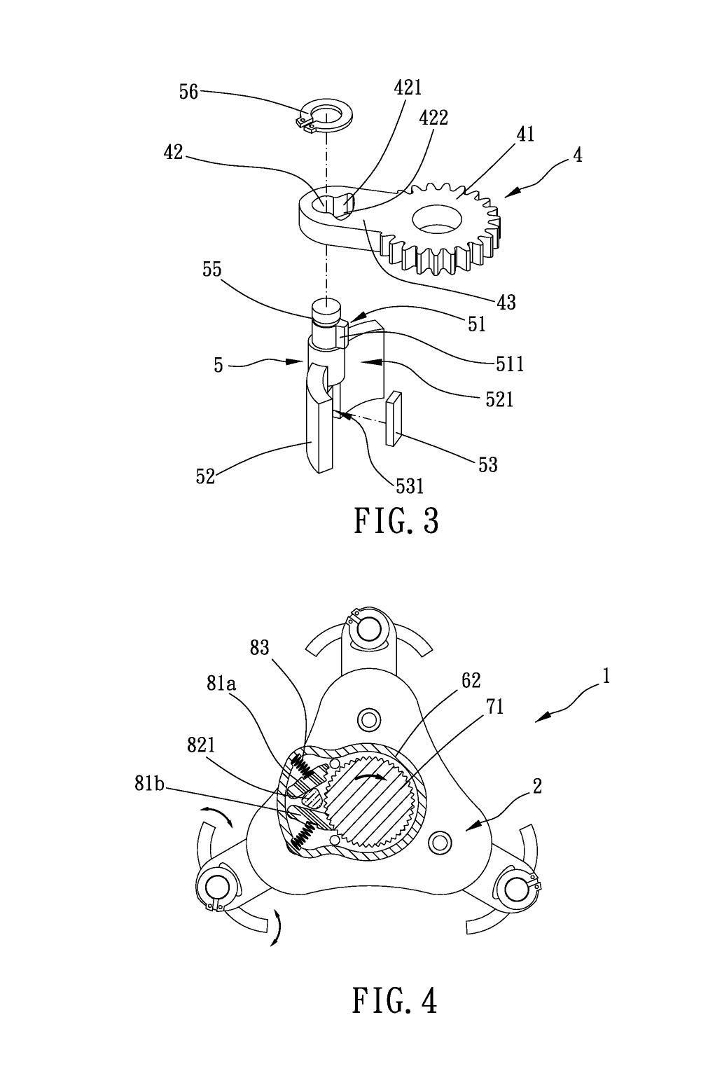

Please refer to FIGS. 3 and 10. It is to be noted that the rotating angle of the restricting portion 51 of each clamping member 5 is restricted by the position-limiting portion 42, so when each clamping member 5 moves closer toward the central axis, the clamping recessed face 521 of each clamping portion 52 is swingable in some ranges in accordance with an outer surface of the oil filter cartridge 9 so as to tightly clamp the outer surface of the oil filter cartridge 9. The clamping recessed face 521 of the clamping portion 52 will not be unable to face the outer surface of the oil filter cartridge 9 due to the inadequately large rotating angle of each clamping member 5. In addition, when each clamping member 5 clamps the oil filter cartridge 9, each clamping portion 52 will not slip off from the oil filter cartridge 9 because each pivotally swinging angle of the clamping member 5 is too great. Therefore, it is convenient to assemble or disassemble the oil filter cartridge 9.

Given the above, in the corresponding pivotally swinging direction of the restricting portion of each clamping member, the position-limiting portion of each rotating member of the dismantling device is formed with one the blocking portion on two sides of the restricting portion; therefore, each restricting portion is restrictedly swingable between the two blocking portions, and the rotating angle of the clamping member is restricted. The clamping recessed face of each clamping portion can pivotally swing in some degrees in accordance with the outer surface of the object to be clamped so as to tightly clamp the outer surface of the object to be clamped.

In addition, each arm includes two rods slidably assembled with each other, and the two rods can selectively mutually slide to extend or shorten the length of the arm in accordance with the dimension of the object to be clamped.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A dismantling device, including:
a main body, having an axial direction;
a major sprocket, being rotatably assembled with the main body;
at least two rotating members, being axially pivoted to the main body and arranged around the axial direction, each rotating member including a minor sprocket portion meshed with the major sprocket and a position-limiting portion, each minor sprocket portion rotating about a central axis;
at least two clamping members, being connected to the rotating members respectively, each clamping member including a restricting portion disposed at the position-limiting portion and a clamping portion;
wherein the restricting portion and the position-limiting portion are mutually restricted, and the restricting portion is restrictedly swingable within the position-limiting portion.

2. The dismantling device of claim 1, wherein in a corresponding pivotally swinging direction of the restricting portion, each position-limiting portion has a blocking portion located on two sides of the restricting portion, each restricting portion includes a protruding portion extending radially, and the protruding portion of the restricting portion is restrictedly swingable between the two blocking portions.

3. The dismantling device of claim 1, wherein each position-limiting portion includes a slot which radially widens.

4. The dismantling device of claim 1, wherein each clamping portion includes a clamping recessed face, each clamping recessed face faces toward the central axis, and a shape of each clamping recessed face corresponds to a shape of an object to be clamped.

5. The dismantling device of claim 1, wherein each rotating member includes an arm extending radially outward from the minor sprocket portion, and each clamping member is connected to one of the arms.

6. The dismantling device of claim 5, wherein each arm includes two rods which are slidably assembled with each other.

7. The dismantling device of claim 1, wherein each clamping member is detachably connected to one of the rotating members.

8. The dismantling device of claim 1, wherein each clamping member further includes an outer layer disposed on an outer surface of the clamping portion.

9. The dismantling device of claim 1, wherein each clamping portion further has a magnetic member.

10. The dismantling device of claim 1, further including a main rotating body, a ratcheting portion and a restriction mechanism, wherein the main rotating body is rotatably assembled to the main body and has a driving portion which is operable from outside, the ratcheting portion includes a ratchet which is rotatably assembled to the main rotating body, the major sprocket links up with the ratchet, the restricting mechanism includes at least one ratcheting member movably assembled to the main rotating body, and each ratcheting member includes at least one tooth selectively meshable with the ratchet.
